(19) United States
(12) Patent Application Publication
(10) Pub. No.: US 2009/0259995 A1
(43) Pub. Date: Oct. 15, 2009

(54) Apparatus and Method for Standardizing Textual Elements of an Unstructured Text

(76) Inventor: William H. Inmon, Castle Rock, CO (US)

Correspondence Address: FOUNTAINHEAD LAW GROUP, PC, 900 LAFAYETTE STREET, SUITE 200, SANTA CLARA, CA, 95050, US

(21) Appl. No.: 12/103,144

(22) Filed: Apr. 15, 2008

(51) Int. Cl. G06F 9/44

(52) U.S. Cl. 717/131

(57) ABSTRACT

In one embodiment the present invention includes a method for standardizing certain textual elements of an unstructured text to enhance the use of the unstructured text as a data source for an analytical processing tool. In accordance with one or more user-defined pre-processing directives, a pre-processing logic identifies textual elements of a certain type, and converts the underlying textual elements to conform to user-defined standards for the particular type. The converted textual element is then inserted into the unstructured text, or an index based on the unstructured text, thereby improving the use of the unstructured text as a data source for conventional analytical processing (e.g., querying) tools.

### FIELD

The present invention relates to the processing and analysis of unstructured textual data. In particular, the present invention relates to an apparatus and method for pre-processing unstructured textual data for the purpose of standardizing certain textual elements, thereby enhancing the processing and analysis that can be performed on the unstructured textual data by automated analytical processing tools.

### BACKGROUND

For many years, decision makers have based decisions primarily on the analysis of data that are often referred to as transaction-based data or structured data. In general, structured data are data that have been formatted or otherwise organized so that it can be efficiently analyzed or used for a specific purpose. For instance, the data associated with deposits, payments and withdrawals made at a bank are forms of structured data. Similarly, the data included in airline reservations, assembly tickets, and retail sales receipts are all examples of structured data. For years, business decisions have effectively been made by analyzing these types of structured data. However, as information and data processing technologies have improved, many decision makers have sought to gain a competitive advantage in the business decision making process by utilizing more sophisticated forms of data—in particular, unstructured data.

Unstructured data are data that have not been formatted or otherwise organized to suit a specific purpose. The term is not precise. For instance, whether data are deemed structured or unstructured may be determined in relation to the specific purpose for which the data are to be used. Accordingly, data with some form of structure may be referred to as unstructured data if the particular structure is not useful for the desired purpose or processing task. Accordingly, many forms of data not suitable for processing with automated analytical processing tools are undeniably classified as unstructured data. While there are many kinds of unstructured data—including audio, video and graphic data—the present invention is concerned with the processing and analysis of unstructured textual data.

Unstructured textual data can be found in many forms. For instance, a body of text with no apparent form or structure may be referred to as simple unstructured textual data. A text with some semblance of implicit structure (e.g., chapters or sections) may be referred to as semi-structured textual data. For example, the text of a recipe book, where each recipe has a distinct beginning and end, may constitute semi-structured textual data. One of the primary characteristics of unstructured textual data in its many forms is that unstructured textual data is typically composed with few, if any, structural composition rules. For instance, when a person drafts an email, there are few, if any, structural composition rules to which the drafter must adhere. Similarly, the author of a book generally has an artistic license to structure the text of the book in any manner he or she desires. In general, the essence of unstructured text is that there are almost no rules for the writing of the text. Because of this, there are many challenges in utilizing unstructured text with automated analytical tools designed to enhance the decision making process. For instance, it is simply not possible to run a query against the body of text in an email in an email client's inbox. Even if the body of text from an email was manually input into a database, its usefulness would still be limited. The examples provided below shed light on the nature of the challenges faced when trying to utilize unstructured text with automated analytical tools in the decision making process.

One particular problem is that the meaning of any textual element (e.g., word, phrase, or sentence) in an unstructured text is frequently dependent upon the terminology and/or context in which it is used. That is, the meaning that is to be attributed to a word or phrase is often dependent upon various aspects of the context in which it is being used. For instance, the meaning of many words or phrases can only be determined properly when considered in the context of the sentence in which the words or phrases are used. Furthermore, the meaning of many words or phrases may be dependent upon whether the words or phrases are part of a technical terminology. This, of course, is frequently dependent upon the characteristics (e.g., background, education, geographical location) of the person using a word or phrase. For instance, a part of the human body may have as many as twenty different names. Accordingly, medical practitioners with different specialties may refer to the same part of the human body by different names or words. A cardiologist may refer to a particular body part differently than a hematologist does. Because of this, it is difficult for an automated analytical processing tool to gain a sense of the context in which a word or phrase is being used. Consequently, the usefulness of raw unstructured text in the decision making process is limited.

Another challenge involves interpreting textual elements such as dates, times and numbers, when such textual elements are not provided in a common or standard format. For instance, in an unstructured text, a date may be expressed in one of several ways. The four dates “12/15/2007”, “2007-12-15”, “December 15, 2007” and “2007 December 15” represent four different formats for expressing the same date. Because the dates are expressed differently, it is difficult for an analytical processing tool to work with the dates in a meaningful way. This problem exists for other units of measure, such as time, as well as written numbers. For instance, the numeric value written in words as “twenty thousand two hundred and thirty three” may not be useful as an input to an analytical tool expecting the value “20233”. Consequently, there exists a need to improve the usefulness of unstructured text as a data source for analytical processing tools used in a decision making process.

### SUMMARY

Embodiments of the present invention improve the manner in which unstructured text can be processed by analytical processing tools, such as query tools. In one embodiment, the present invention includes pre-processing logic for pre-processing unstructured text, thereby placing the unstructured text in a condition more suitable for use as a data source by one or more analytical processing tools. The pre-processing logic searches the unstructured text for textual elements (e.g., words, phrases, or numbers) that are expressed in a manner inconsistent with user-specified standard formats, and then generates a representation of the textual element that conforms to the user-specified standard format. The representation of the textual element generated by the pre-processing logic may be inserted directly into the unstructured text, or alternatively, inserted into an index, database or data warehouse where it can be utilized as a data source by an analytical processing tool.

Depending on the particular implementation, standard formats may be specified by a user for a variety of different textual element types, to include dates, times, numbers, and other units of measure such as weights, lengths, or temperatures. In addition, a special type of textual element includes a word or phrase that is included in a user-specified taxonomy or listing of words. For instance, if a word included in the unstructured text appears within a user-specified taxonomy or listing of words, that word may be replaced or represented by another word or phrase, as indicated by the taxonomy or listing of words. For example, a user may specify a listing of different fruits, such as apples, bananas, pears, and so on. Each time a fruit name appears in the unstructured text, the alternative word “fruit” may be inserted into the text, or a searchable index, database or data warehouse. Consequently, an analytical processing tool executing a query against one or more unstructured texts that have been pre-processed in this manner is able to issue a query for fruit, as opposed to a specific type of fruit.

In yet another aspect of the invention, the pre-processing logic may analyze the unstructured text to determine the proximity of two textual elements with respect to one another. If, for example, two words appear within an unstructured text within a user-specified proximity to one another, the pre-processing logic may replace or otherwise represent the two words with an alternative word or phrase. For instance, when the words “Denver” and “Broncos” appear within the unstructured text within a predefined proximity, the pre-processing logic may provide an alternative “standardized” word or phrase (e.g., football team) to represent the two words found within close proximity to one another.

The following detailed description and accompanying drawings provide additional understanding of the nature and advantages of the present invention.

### BRIEF DESCRIPTION OF THE DRAWINGS

The accompanying drawings, which are incorporated in and constitute a part of this specification, illustrate an implementation of the invention and, together with the description, serve to explain the advantages and principles of the invention. In the drawings:

FIG. 1 illustrates an example of a pre-processing logic, according to an embodiment of the invention, for pre-processing unstructured text to improve the text's use as a data source for an analytical data processing tool;

FIG. 2 illustrates three example snippets of text expressing dates in three different formats, along with an alternative representation of each date specified in a standardized format, in accordance with an embodiment of the invention; from various sources of unstructured text;

FIGS. 3 and 4 illustrate examples of an index with words from an unstructured text before and after pre-processing logic has added alternative representations of certain words that are included in a taxonomy of words, according to an embodiment of the invention;

FIG. 5 illustrates an example of an index including words from an unstructured text before and after pre-processing logic has added an alternative word to represent the existence of two specific words within close proximity to one another, according to an embodiment of the invention;

FIG. 6 illustrates an example of an index including words from an unstructured text before and after pre-processing logic has added a variable to represent the existence of two specific words within close proximity to one another, according to an embodiment of the invention; and

FIG. 7 is a block diagram of an example computer system and network for implementing embodiments of the present invention

### DETAILED DESCRIPTION

Described herein are techniques for standardizing certain textual elements of an unstructured text, thereby enhancing the use of the unstructured text as a data source for certain analytical data processing tools. In the following description, for purposes of explanation, numerous examples and specific details are set forth in order to provide a thorough understanding of the present invention. It will be evident, however, to one skilled in the art that the present invention as defined by the claims may include some or all of the features in these examples alone or in combination with other features described below, and may further include modifications and equivalents of the features and concepts described herein.

In one aspect, the present invention involves analyzing an unstructured text to identify textual elements of a particular type that are expressed in formats inconsistent with predefined standard formats for each type of textual element. As used herein, the term “textual element” refers to a word, phrase or number within the unstructured text. For example, a date written as “December 15, 2007” is a textual element of the “date” type. Although there may be a wide variety of textual element types in any particular embodiment of the invention, the examples provided herein include dates, times, written numbers, and a special type referred to herein as a “taxonomy word” type. Those skilled in the art will appreciate that the invention is independent of any particular nomenclature used to specify the various textual element types, variable names, and so forth.

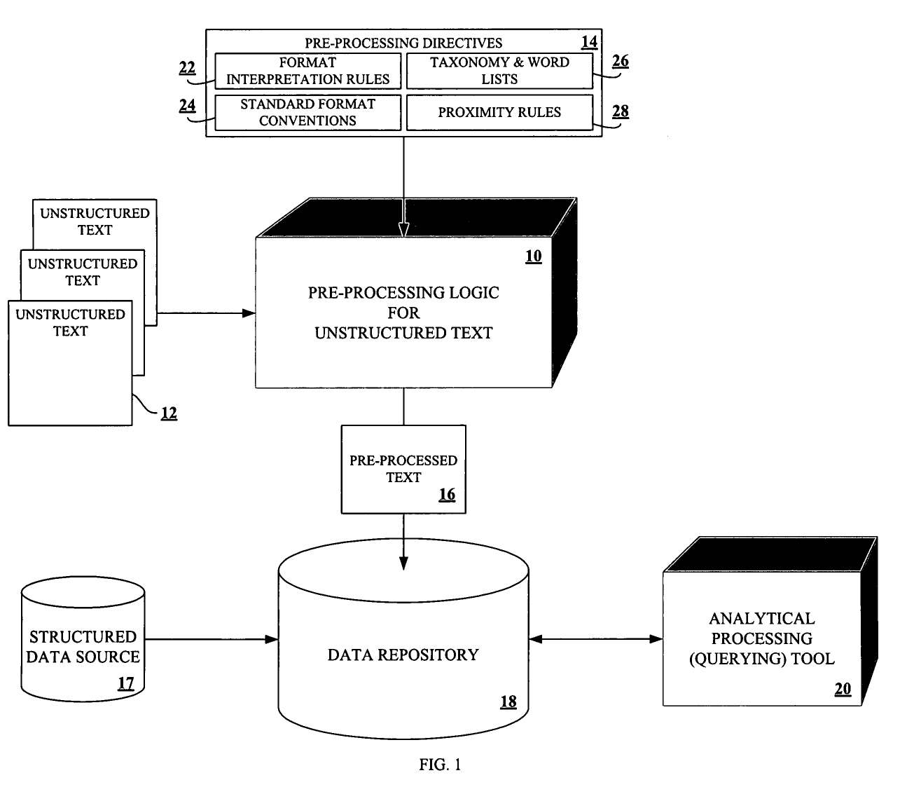

FIG. 1 illustrates an example of pre-processing logic 10, according to an embodiment of the invention, for pre-processing unstructured text to improve the text's use as a data source for analytical data processing tools. Although the pre-processing 10 logic might be implemented in part, or entirely, in hardware, generally the pre-processing logic 10 is implemented as part of a software application. As such, the pre-processing logic 10 may be implemented to operate on a wide variety of computer systems, and the present invention is independent of any particular hardware or software platform. Furthermore, the processing directives and operations described herein are sometimes referred to as pre-processing directives and operations in view of the additional processing that occurs after the unstructured text(s) have been conditioned for use as a data source for one or more analytical processing tools 20.

As illustrated in FIG. 1, the pre-processing logic 10 takes as input one or more unstructured texts 12 and a set of pre-processing directives 14, processes the unstructured text(s) 12 in accordance with the pre-processing directives 14, and then outputs pre-processed text 16 to a data repository 18. The exact format of the pre-processed text 16 output by the pre-processing logic 10 may vary depending upon the particular implementation and the data repository 18 being utilized. Furthermore, the pre-processed text 16 may be combined or associated with one or more other data sources, to include a structured data source 17. For instance, if the data repository 18 is a database, the pre-processed text 16 may be output in a form that allows it to easily be inserted into one or more database tables along with data from an additional structured data source 17. The data repository 18 may be an index, a database, a data warehouse, or any other data container suitable for storing the pre-processed text 16 in a manner suitable for analysis by analytical processing tools 20. The pre-processing directives 14 used in processing the unstructured text(s) 12 include format interpretation rules 22, standard format conventions 24, taxonomy and word lists 26 and proximity rules 28.

The first set of pre-processing directives—the format interpretation rules 22—is user-configurable and instructs the pre-processing logic 10 on how to interpret various textual elements found in an unstructured text. A different format interpretation rule 22 may be defined for each textual element type to indicate how that particular textual element type (e.g., dates, times, numbers) is to be interpreted by the pre-processing logic 10. Furthermore, a default format interpretation rule may be specified for those instances when a user-specified format interpretation rule cannot be used to accurately infer the meaning of a textual element. For instance, the date, December 15, 2007, may be specified in an unstructured text as, 12-2008-15. A format interpretation rule may specify how the textual element, 12-2008-15, should be interpreted by the pre-processing logic 10. The format interpretation rule may indicate whether “15” is to be interpreted as a day, month or year. In one embodiment of the invention, user-specified format interpretation rules 14 may specify an order or priority for which different formats are to be used in interpreting a textual element. If, for example, it is more likely that a date will appear in one format over another (e.g., because the source document was generated in a particular geographical location), then that format which is most likely to occur in the unstructured text will be used first in attempting to interpret the date. In many cases, the proper value of a textual element can be inferred from the value and format provided. As an example, the numbers “15” in the date, 12-2008-15, will be interpreted as a day, because it does not make sense if interpreted as a month. However, in certain situations, it may not be possible to properly infer the correct format based on the values given. In these situations, the default interpretation rule will be used.

The next pre-processing directive—the standard format conventions 24—indicate for each textual element type the standard format that is used in generating the pre-processed text 16. Accordingly, a standard format for a textual element type may be specified to match that format expected by the analytical processing tools 20. For instance, if an analytical processing tool 20 expects dates to be written in the form, “YYYYDDMM”, where “YYYY” indicates a four-number year, “DD” indicates a two-number day, and “MM” indicates a two-number month, then the standard format convention for date type textual elements will direct the pre-processing logic 10 to use the specific format for dates. The standard format conventions 24 can be configured by a user for each textual element type. If there is no user-specified standard format convention for a particular textual element type, the pre-processing logic 10 may utilize a default standard format for that textual element type.

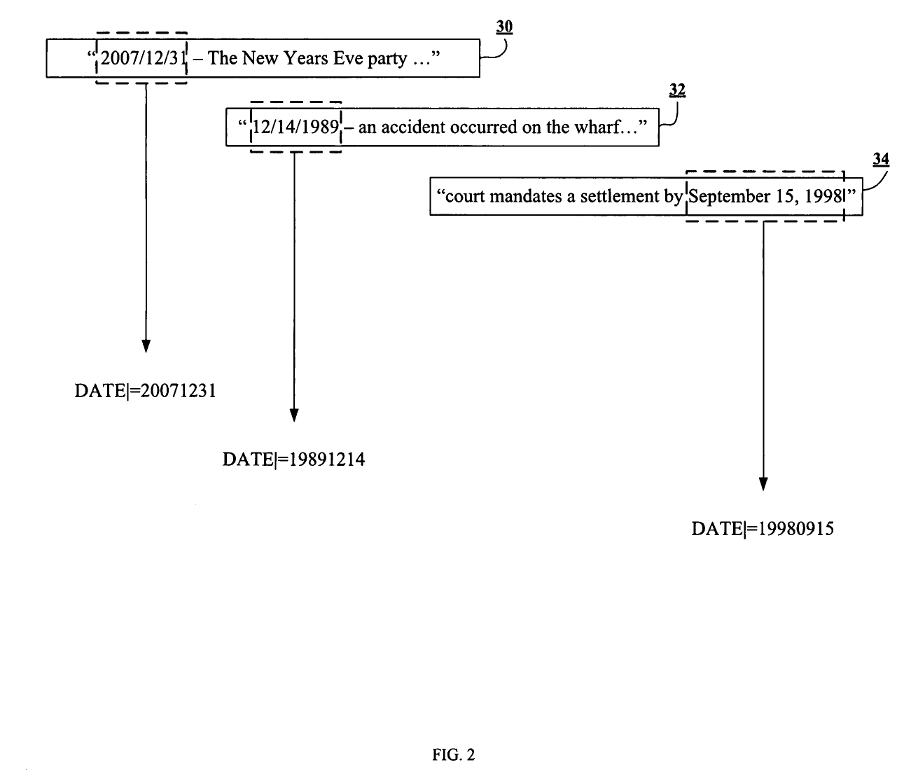

FIG. 2 illustrates three snippets of text 30, 32 and 34 from various sources of unstructured text. Each snippet of text includes a date specified in a different format. For instance, the first snippet includes a date specified as, 2007/12/31. The second includes a date specified as, 12/14/1989, while the third snippet has the date, September 15, 1989. When the pre-processing logic 10 processes these snippets of text, it will use the format interpretation rules 22 to determine the proper date, given the provided values. After mapping each value (e.g., 2007) to the proper unit (e.g., year), the pre-processing logic 10 uses the standard format conventions 24 to format each date in accordance with a specified standard format for dates. In this case, the standard format includes specifying the date in variable format with a variable name “DATE” and a variable value for the date in the form “YYYYMMDD”. The symbol “|=” indicates that the variable “DATE” takes on the corresponding value, for example, “20071231”.

Another set of pre-processing directives shown in FIG. 1 is the taxonomy and word lists 26. As described below in greater detail, the taxonomy and word lists 26 are just that—taxonomies and word lists. The taxonomies and word lists 26 are used by the pre-processing logic 10 to generate alternative representations of certain textual elements found in the unstructured text 12. For example, a user may create a taxonomy that categorizes fruits and vegetables. The pre-processing logic 10 will identify when a word included in the taxonomy occurs in the unstructured text and then generate an alternative representation of that word. For example, every time a fruit name (e.g., apple, banana, or pear) appears in the unstructured text, the word “fruit” may be inserted into the unstructured text as an alternative representation of the specific fruit.

In one embodiment of the invention, the pre-processing logic 10 includes a user interface component (not shown) that allows a user to create, import and/or edit various taxonomies or word lists. Accordingly, existing commercial taxonomies can be imported into an application, edited if necessary, and utilized with the pre-processing logic 10 to process unstructured text. Similarly, the user interface component enables new word lists and taxonomies to be generated, edited and saved for later use.

Another type of pre-processing directive 14 illustrated in FIG. 1 that can be configured by the user is referred to herein as proximity rule 28. A proximity rule 28 specifies when the pre-processing logic 10 should generate an alternative representation of a pair of textual elements that are identified within the unstructured text within a predefined proximity to one another. For example, a user may want to insert an alternative textual element when two textual elements are located close together. Accordingly, the user can generate a proximity rule that instructs the pre-processing logic 10 to generate and insert the alternative representation when two specific textual elements occur within a specified proximity. In various embodiments of the invention, the proximity may be specified in different ways, such as by the number of words between two textual elements, the number of characters, or the number of bytes.

In one embodiment of the invention, the pre-processing logic 10 takes an iterative approach in processing the unstructured text 12. For example, the pre-processing logic 10 may make several “passes” over the unstructured text, performing a different processing task for each pass. For instance, during a first pass, the pre-processing logic 10 may create an index that includes only those textual elements determined to be relevant. This determination may be made in accordance with some built-in logic that recognizes sentence structure, punctuation and other basic grammatical rules. For instance, articles and prepositions may be excluded. Once an index is created with those textual elements deemed relevant, the pre-processing logic 10 may make a second pass performing a processing task consistent with one of the user-specified pre-processing directives. For instance, during the second pass, the pre-processing logic 10 may identify a certain type of textual element (e.g., numbers), and generate and insert into the index alternative representations of those textual elements conforming to user-specified standard formats. In each subsequent pass or processing phase, a different pre-processing directive is performed until the pre-processing logic 10 has completely processed the unstructured text in accordance with all user-specified pre-processing directives 14. The order in which the pre-processing directives are processed may be user-defined. Furthermore, in an alternative embodiment of the invention, the pre-processing logic 10 may perform multiple processing tasks in a single pass.

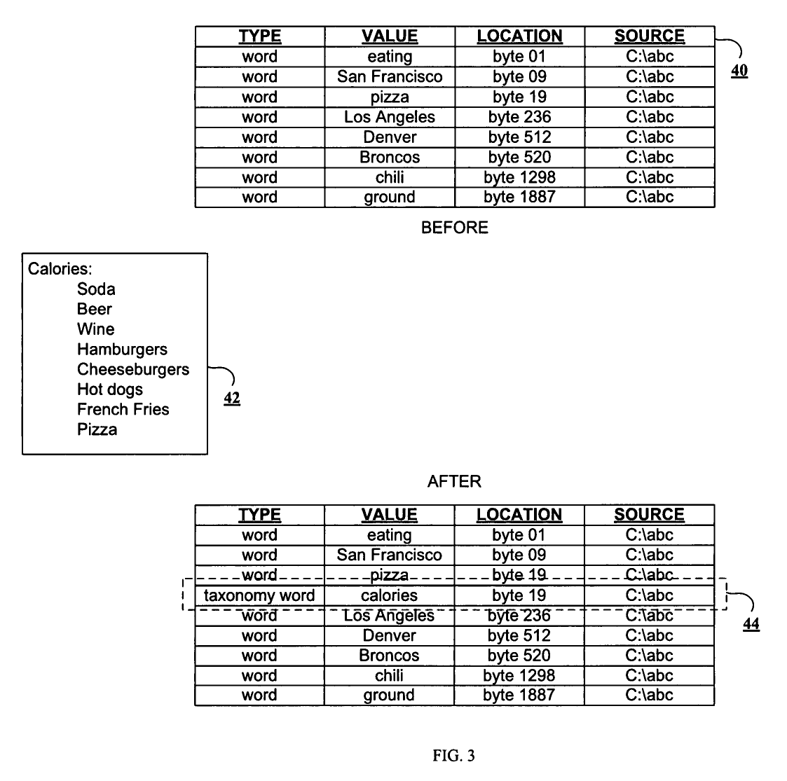

In the examples illustrated in FIGS. 3, 4, and 5, an index is shown in table form both before and after the pre-processing logic 10 has performed a pre-processing operation consistent with a user-specified pre-processing directive. In each example, the table representing the unstructured textual data before the pre-processing directive has been performed shows an initial index created by the pre-processing logic from an unstructured text. That is, the pre-processing logic 10 has created an initial index shown in table form that includes only those textual elements that have been deemed relevant. To illustrate how a particular pre-processing directive may affect the initial index (shown in the table labeled “BEFORE”), the same index (shown in the table labeled “AFTER”) is shown after the pre-processing directive has been processed by the pre-processing logic 10.

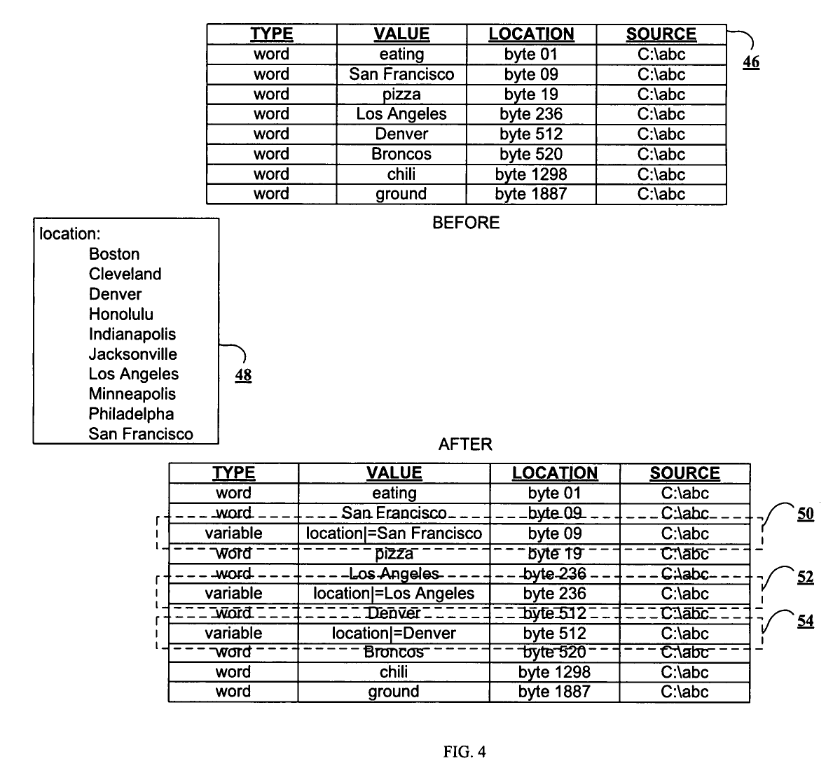

FIGS. 3 and 4 illustrate examples of how a taxonomy or word list may be utilized, according to an embodiment of the invention, to standardize textual elements in an unstructured text. As illustrated in FIG. 3, the table with reference number 40 represents an index of textual elements (in this case, words) that has been generated from an unstructured text. In the table 40, the column with heading “TYPE” indicates the type of textual element, while the column with heading “VALUE” indicates the exact word that has been extracted from the unstructured text. The columns labeled “LOCATION” and “SOURCE” specify the position or location of the word within the text, and the file (or source) from which the word or phrase was extracted, respectively. In one embodiment of the invention, the pre-processing logic 10 analyzes the words in the table 40 to determine if any of the words are included in a taxonomy or listing of words, such as that shown in FIG. 3 with reference number 42. In this example, the word “pizza”, which according to table 40 appears at byte 19 of the file with path and name, “C:\abc”, is also included in the list of words 42 under the heading, “calories”. Accordingly, the pre-processing logic 10 inserts a new row 44 into table 40 adding the word “calories”, which for purposes of the analytical processing tool is viewed as a representation of the word “pizza”. The analytical processing tool can now query the index for the word, “calorie”, and depending upon the particular configuration of the tool, “pizza” and/or “calorie” will be returned in response to the query.

In FIG. 4, the result of a similar pre-processing directive is shown. In particular, FIG. 4 illustrates how the alternative representation of a particular word identified in the original unstructured text may be specified as a variable. For example, as illustrated in FIG. 4, a taxonomy or list of words 48 is used to generate variables associated with particular locations specified as proper nouns. As illustrated in the partially processed unstructured text represented by the index of table 46, the words “San Francisco”, “Los Angeles”, and “Denver” are shown. In a particular application, it may be desirable to have these particular proper nouns represented as or assigned to variables, with a variable name of “location.” This enables a user of an analytical processing tool to easily specify a query utilizing the variable and specific values assigned to the variable. To achieve this, a user may create a pre-processing directive that, when processed by the pre-processing logic 10, identifies certain words in the unstructured text which are also included in a list or taxonomy of words (e.g., taxonomy 48), and assigns those words to a new variable that is inserted into the index. For instance, as illustrated in FIG. 4, the word “San Francisco” has been assigned to a new variable with name “location”, and inserted into the index 50. In this example, the characters “|=” are interpreted as a variable assignment operator. Similarly, as indicated by the rows 52 and 54 of table 46 in FIG. 4, a variable has been generated for the locations corresponding to “Los Angeles” and “Denver” as well.

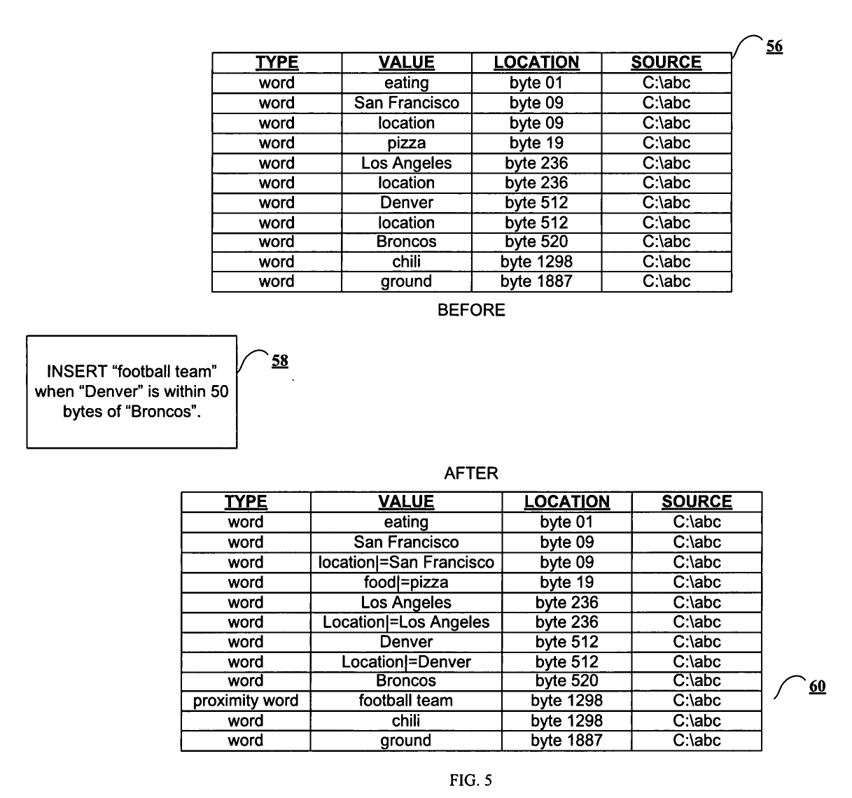

FIG. 5 illustrates an example of an index 56 including words from an unstructured text before and after pre-processing logic 10 has added an alternative word representing the existence of two specific words within close proximity to one another, according to an embodiment of the invention. In one embodiment of the invention, a user-defined pre-processing directive 58 may specify what is referred to herein as a proximity rule. As used herein, a proximity rule is a rule that performs some processing task when the pre-processing logic 10 identifies two textual elements within close proximity to one another in an unstructured text. The textual elements may be words, phrases, variables, or variable values. Furthermore, the particular measure of proximity may be different in various embodiments of the invention, and will generally be user-definable. Accordingly, when defining a particular proximity rule a user may specify that an action is to be taken when a first textual element is found to be within a certain range or distance (specified in words, bytes or some other measure) of another textual element. Furthermore, the user-defined proximity for a proximity rule may also be specified in terms of its direction. For instance, a proximity rule may be defined such that the pre-condition that must be satisfied in order for the processing task to be performed requires that a first word be located within a particular direction of a second word, for example, after or before the second word.

Turning again to the specific example illustrated in FIG. 5, there is shown a table with an index representing unstructured text before and after the pre-processing logic 10 has processed a proximity rule 58. In this case, the proximity rule 58 has been specified to insert the phrase “football team” when a variable named “location” has assigned to it the value “Denver”, and is located within fifty bytes of the word “Broncos”. As illustrated in the table 56 of FIG. 5, the word Denver appears at byte offset 512 in the file “C:\abc”, and the word “Broncos” appears at byte offset 520. Accordingly, the proximity rule 48 causes the word “football team” to be inserted into the index, as indicated by row 60 in FIG. 5. Although the word “football team” is inserted at the same byte location as the word “Broncos” byte 520 in the example, the particular location of the inserted word or variable may vary depending upon the proximity rule. For instance, the inserted word or variable (e.g., “football team” in the example of FIG. 5) may be inserted at the location of the first word (e.g., “Denver”) in the word pair specified by the proximity rule, or the second word (e.g., “Broncos”), or somewhere in between, before or after. In one embodiment of the invention, the location of the inserted word is determined by the proximity rule, and is user-definable.

It will be appreciated by those skilled in the art that the proximity rule shown in FIG. 5 is in essence pseudo-code that is meant to serve as an example. Depending upon the particular implementation, the proximity rule may be specified in a variety of ways. In one embodiment of the invention, a graphical user interface may include a pre-processing directive editor that enables a user to specify various pre-processing directives, including proximity rules. For instance, such an editor may enable a user to save and reuse certain pre-processing directives with different unstructured texts.

In defining a proximity rule, the textual elements being analyzed may be words included in the original unstructured text, or words and/or variables that have been inserted into the unstructured text as a result of a previously processed pre-processing directive. Accordingly, the order in which the pre-processing directives are processed may play a part in determining the resulting index. If, for instance, a first pre-processing directive results in the addition to the unstructured text of a particular word, this additional word may be specified in a proximity rule, such that the proximity rule causes yet another textual element (word or variable) to be added to the unstructured text when the particular word is identified during the processing of the proximity rule. By way of example, a first pre-processing directive may cause the pre-processing logic to standardize the format of all dates expressed within the unstructured text. A second pre-processing directive may cause the pre-processing logic to insert the word Christmas into the unstructured text whenever the data December 25 is found within the unstructured text and expressed in user-defined the standard format for dates.

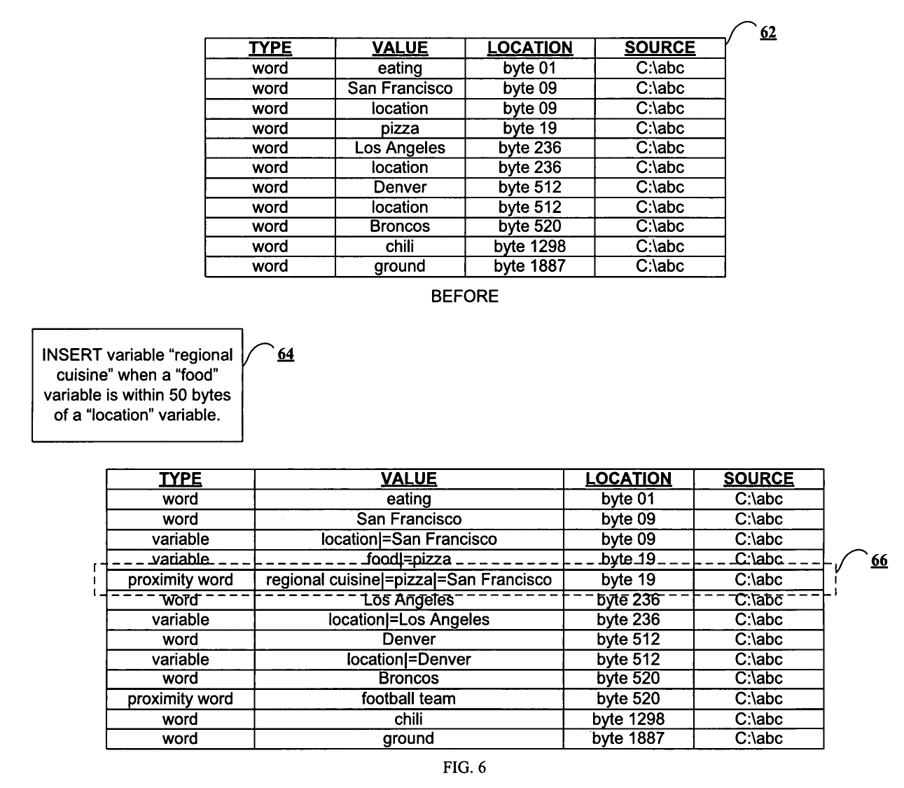

Although the example shown in FIG. 5 illustrates a proximity rule for which an alternative word is inserted into the unstructured text when two textual elements are within proximity to one another, in an alternative embodiment, a proximity rule may be based on the existence of three, four or even more textual elements being located within a user-defined proximity to one another. Furthermore, as described in connection with the example of FIG. 6, a variable name may be assigned a value when two or more words are within a user-defined proximity to one another.

In one final example, FIG. 6 illustrates an index 62 including words from an unstructured text before and after pre-processing logic has added a variable (e.g., the row with reference number 66) to represent the existence of two specific words within close proximity to one another, according to an embodiment of the invention. As illustrated in FIG. 6, the variable with variable name “regional cuisine” has been assigned a value of “pizza” for the location of “San Francisco”. This assignment is the result of processing the proximity rule included in the pre-processing directive 64.

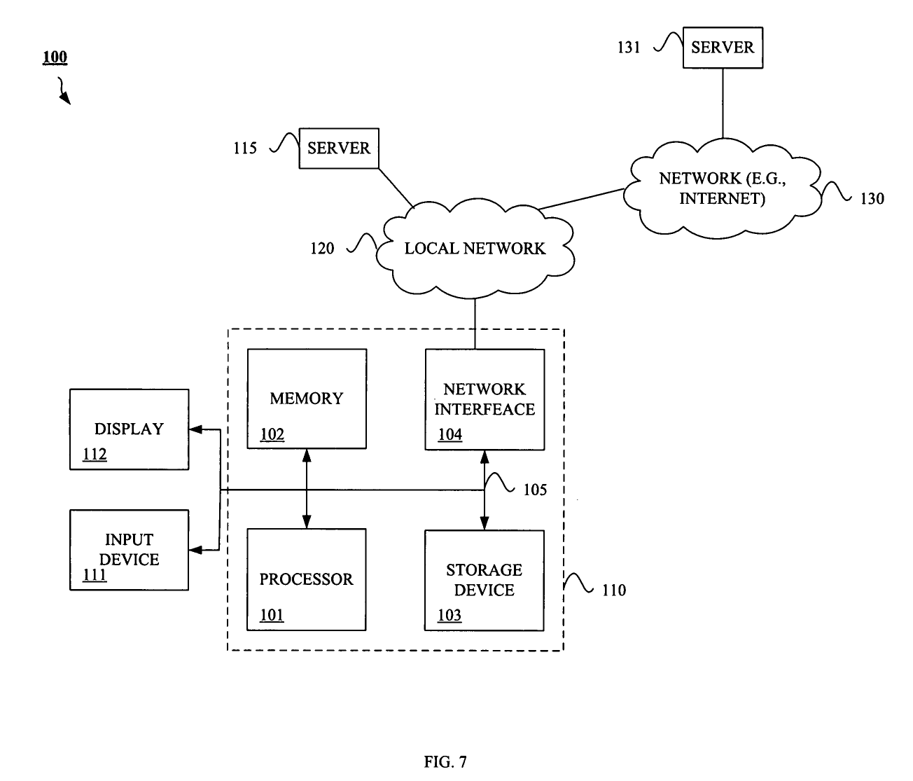

FIG. 7 is a block diagram of an example computer system and network 100 for implementing embodiments of the present invention. Computer system 110 includes a bus 105 or other communication mechanism for communicating information, and a processor 101 coupled with bus 105 for processing information. Computer system 110 also includes a memory 102 coupled to bus 105 for storing information and instructions to be executed by processor 101, including information and instructions for performing the techniques described above. This memory may also be used for storing temporary variables or other intermediate information during execution of instructions to be executed by processor 101. Possible implementations of this memory may be, but are not limited to, random access memory (RAM), read only memory (ROM), or both. A non-volatile mass storage device 103 is also provided for storing information and instructions. Common forms of storage devices include, for example, a hard drive, a magnetic disk, an optical disk, a CD-ROM, a DVD, a flash memory, a USB memory card, or any other medium from which a computer can read. Storage device 103 may include source code, binary code, or software files for performing the techniques or embodying the constructs above, for example.

Computer system 110 may be coupled via bus 105 to a display 112, such as a cathode ray tube (CRT), liquid crystal display (LCD), or organic light emitting diode (OLED) for displaying information to a computer user. An input device 111 such as a keyboard and/or mouse is coupled to bus 105 for communicating information and command selections from the user to processor 101. The combination of these components allows the user to communicate with the system. In some systems, bus 105 may be divided into multiple specialized buses.

Computer system 110 also includes a network interface 104 coupled with bus 105. Network interface 104 may provide two-way data communication between computer system 110 and the local network 120. The network interface 104 may be a digital subscriber line (DSL) or a modem to provide data communication connection over a telephone line, for example. Another example of the network interface is a local area network (LAN) card to provide a data communication connection to a compatible LAN. Wireless links is also another example. In any such implementation, network interface 104 sends and receives electrical, electromagnetic, or optical signals that carry digital data streams representing various types of information.

Computer system 110 can send and receive information, including messages or other interface actions, through the network interface 104 to an Intranet or the Internet 130. In the Internet example, software components or services may reside on multiple different computer systems 110 or servers 131 across the network. A server 131 may transmit actions or messages from one component, through Internet 130, local network 120, and network interface 104 to a component on computer system 110.

As indicated by the examples illustrated and described herein, an embodiment of the invention provides great flexibility in defining pre-processing directives and manipulating an unstructured text in order to condition the text for analysis by one or more analytical processing tools. The above description illustrates various embodiments of the present invention along with examples of how aspects of the present invention may be implemented. The above examples and embodiments should not be deemed to be the only embodiments, and are presented to illustrate aspects and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims.

To further aid in conveying various aspects of the invention, attached hereto as Appendix A and B, and part of this specification, are user manuals for one particular implementation of a software tool that facilitates and/or embodies various aspects of the invention.

What is claimed is:

1. A computer-implemented method comprising:
analyzing an unstructured text to identify a textual element of a particular type that is expressed in a format inconsistent with a predefined standard format for that particular type of textual element;
generating a representation of the textual element that conforms to the predefined standard format for that particular type of textual element; and
adding the representation of the textual element to a data repository so as to make the representation of the textual element available to an analytical tool for analyzing the unstructured text.

2. The computer-implemented method of claim 1, wherein the particular type of the textual element is a date, a time, or written number; and
generating a representation of the textual element that conforms to the predefined standard format for that particular type of textual element includes converting a date, time or written number to a format that conforms to a predefined standard format for a date, time or written number.

3. The computer-implemented method of claim 1, wherein the particular type of the textual element is a word included in a taxonomy or listing of words; and
generating a representation of the textual element that conforms to the predefined format for that particular type of textual element includes generating an alternative word to represent the word in the unstructured text, the alternative word selected based on the taxonomy or listing of words.

4. The computer-implemented method of claim 1, wherein the particular type of the textual element is a word included in a taxonomy or listing of words; and
generating a representation of the word included in the taxonomy or listing of words includes generating a variable name based on the taxonomy or listing of words, and assigning the textual element to the variable name.

5. The computer-implemented method of claim 1, wherein adding the representation of the textual element to a data repository includes inserting the representation of the textual element into the unstructured text prior to adding the unstructured text to the data repository.

6. The computer-implemented method of claim 1, wherein adding the representation of the textual element to a data repository includes inserting the representation of the textual element into an index associated with the unstructured text prior to adding the index and the unstructured text to the data repository.

7. The computer-implemented method of claim 1, wherein the predefined standard format for each type of textual element is user-definable.

8. The computer-implemented method of claim 1, wherein adding the representation of the textual element to a data repository includes adding to the data repository additional contextual information related to the textual element.

9. The computer-implemented method of claim 8, wherein the additional information includes one or more of: information indicating the position of the textual element within the unstructured text, information indicating the source of the unstructured text, and/or information indicating the type of the textual element.

10. A computer-implemented method comprising:
analyzing an unstructured text to identify a textual element that is located within a predefined proximity of another textual element within the unstructured text;
generating a variable representative of one or both of the textual elements; and
adding the variable to a data repository in a manner that makes the variable accessible to an analytical tool for analyzing the unstructured text.

11. The computer-implemented method of claim 10, wherein the predefined proximity is specified as a distance measured in words, characters or bytes, and is user-configurable.

12. The computer-implemented method of claim 10, wherein adding the variable to a data repository in a manner that makes the variable accessible to an analytical tool for analyzing the unstructured text includes inserting the variable into the unstructured text prior to adding the unstructured text to the data repository.

13. The computer-implemented method of claim 10, wherein adding the variable to a data repository in a manner that makes the variable accessible to an analytical tool for analyzing the unstructured text includes inserting the variable into an index associated with the unstructured text prior to adding the index and the unstructured text to the data repository.

14. The computer-implemented method of claim 10, wherein the variable includes a variable name and a variable value assigned to the variable name.

15. An apparatus for conditioning unstructured text for use by an analytical processing tool, the apparatus comprising:
pre-processing logic configured to i) analyze an unstructured text to identify a textual element of a particular type that is expressed in a format inconsistent with a predefined standard format for that particular type of textual element, ii) generate a representation of the textual element that conforms to the predefined standard format for that particular type of textual element, and iii) add the representation of the textual element to a data repository so as to make the representation of the textual element available to an analytical tool for analyzing the unstructured text.

16. The apparatus of claim 15, wherein the particular type of the textual element is a date, a time, or written number, and the pre-processing logic is configured to convert a date, time or written number to a format that conforms to a predefined standard format for a date, time or written number.

17. The apparatus of claim 15, wherein the particular type of the textual element is a word included in a taxonomy or listing of words, and the pre-processing logic is configured to generate an alternative word to represent the word in the unstructured text, the alternative word selected based on the taxonomy or listing of words.

18. The apparatus of claim 15, wherein the particular type of the textual element is a word included in a taxonomy or listing of words, and the pre-processing logic is configured to generate a variable name based on the taxonomy or listing of words, and assign the textual element to the variable name, prior to adding the representation of the textual element to the data repository

19. The apparatus of claim 15, further comprising:
a user interface component configured to facilitate defining one or more pre-processing directives by which the pre-processing logic determines the textual element types to be identified and the predefined formats for those textual element types.

20. An apparatus for conditioning unstructured text for use by an analytical processing tool, the apparatus comprising:
pre-processing logic to process the unstructured text in accordance with one or more user-defined pre-processing directives, wherein one pre-processing directive causes the pre-processing logic to i) analyze the unstructured text to identify a textual element that is located within a predefined proximity of another textual element within the unstructured text, ii) generate a variable representative of one or both of the textual elements, and iii) add the variable to a data repository in a manner that makes the variable accessible to an analytical processing tool for analyzing the unstructured text.

21. The apparatus of claim 20, wherein the predefined proximity is specified as a distance measured in words, characters or bytes, and is user-configurable.

22. The apparatus of claim 20, wherein adding the variable to a data repository in a manner that makes the variable accessible to an analytical tool for analyzing the unstructured text includes inserting the variable into the unstructured text prior to adding the unstructured text to the data repository.

23. The apparatus of claim 20, wherein adding the variable to a data repository in a manner that makes the variable accessible to an analytical tool for analyzing the unstructured text includes inserting the variable into an index associated with the unstructured text prior to adding the index and the unstructured text to the data repository.

24. The apparatus of claim 20, wherein the variable includes a variable name and a variable value assigned to the variable name.
